(19) United States
(12) Patent Application Publication
(10) Pub. No.: US 2013/0113220 A1
(43) Pub. Date: May 9, 2013

(54) Fluid-driven power generation apparatus and system for generating electricity and method of assembling the fluid-driven power generation apparatus

(71) Applicant: George Staples, Oklahoma City, OK (US)

(72) Inventor: George Staples, Oklahoma City, OK (US)

(73) Assignee: TribalCom, LLC

(21) Appl. No.: 13/373,208

(22) Filed: Nov. 7, 2011

(51) Int. Cl. H02K 7/18

(52) U.S. Cl. 290/1 A

(57) ABSTRACT

Fluid-driven power generation apparatus and system for generating electricity and method of assembling the fluid-driven power generation apparatus. The fluid-driven power generation apparatus and system comprises a container for containing a fluid, such as water. An electrically operable pump pumps the fluid from the container to a nozzle disposed near a turbine wheel. The pump is powered by batteries, so that the pump operates pollution-free without combustion of fossil fuels. Fluid from the nozzle jets onto the turbine wheel to rotate the turbine wheel. The nozzle and turbine wheel are configured so that optimal rotation of the turbine wheel is achieved for efficient electricity generation. An electrical generator coupled to the turbine wheel generates electricity as the turbine wheel rotates. The electricity generated is supplied to an end user and any excess electricity is provided to an electrical transmission grid.

### FIELD OF THE INVENTION

This invention generally relates to electric power generators and more particularly relates to fluid-driven power generation apparatus, systems and methods.

### BACKGROUND OF THE INVENTION

Generation of electricity by large-scale central power stations is becoming more expensive for consumers of electric power. Hence, there is an incentive for consumers to use electricity generated by on-site means and thereby reduce reliance on electric power generated by large-scale central power stations. In this regard, one factor contributing to high electric energy costs is that the cost of electricity transmission and distribution lines is included in consumer electric bills. Use of on-site power can decrease this cost to the consumer because the cost of electricity transmission and distribution lines is avoided. Other factors contributing to higher costs for electricity generated by large-scale central power stations include decreased worldwide supply of fossil fuels to generate power, higher costs for fossil fuels to generate power, increased worldwide demand for electric power, costs to replace aging power plants and aging transmission/distributions systems, increased costs for power generation equipment (e.g., large-scale electric generators), dollar monetary policy, commodity speculation, and cartel activity, in addition to other factors. For example, in the United States, since year 2000, electricity prices have increased at an annual rate of 2.5 percent, which is higher than the percentage rate of inflation. Also, it is estimated that carbon control regulations in addition to emission taxes may increase consumer electric bills by 50% or more over the next 10 years.

Yet another issue associated with electricity production by large-scale central power stations is that about 4.2 to 8.9 percent of the electricity produced may be lost due to aging transmission equipment, as well as due to other factors. Use of on-site electricity production avoids this power loss. In addition, it is known that reliability of electricity from utility central power stations may vary due to variations in voltage, switching problems on the electrical transmission network, voltage dips, and power transients, in addition to other reliability issues.

In addition, another issue associated with electricity production by large-scale central power stations is that such large-scale central power stations may present an increased national security risk when compared to on-site facilities that are more decentralized. That is, a successful terrorist attack on a single large-scale central power station could create a greater disruption in electricity supply than an attack on a single on-site power facility. Moreover, security at a critical site, such as a military base, may be customized so that security is made more stringent than the security that might be achievable at a civilian-operated large-scale central power station.

Further, on-site electricity production is necessary when the site facility is located remotely from central power station transmission and distribution lines. This can occur, for example, in the case of remotely located vacation resorts and military installations. This can also occur in the case of individual consumers living in remote areas not served by large-scale central power stations. Also, absence of electricity may be of particular concern in underdeveloped or “third world” countries where capital resources to build large-scale central power stations and associated transmission/distribution lines are limited.

There are other situations that make on-site electricity generation desirable. For example, on-site electricity generation is desirable as back-up power when electricity is unavailable from a utility distribution grid. Such a situation may occur during a “blackout”, which is a wide-area disruption in electrical energy supply. Such blackouts can occur due solely to operator error or due to equipment failure caused by a natural disaster, such as an earthquake, tornado or hurricane. Critical facilities that require electricity even during blackouts include hospitals, nursing homes, military bases, as well as other facilities.

Although use of on-site electricity generation obtains several benefits, such use of on-site electricity generation should preferably avoid use of fossil fuels. This is so because reserves of fossil fuels are diminishing as demand for use of fossil fuels is increasing. This creates a need to generate electricity from sources other than from fossil fuels. Fossil fuels (i.e., oil, coal and natural gas) supply about 86% of all energy consumption worldwide. More specifically, worldwide energy consumption percentages from oil, coal and natural gas are about 37.3%, 25.3% and 23.3%, respectively. Sources of energy other than from fossil fuels include nuclear, solar energy captured by solar photovoltaic cells, solar heat, biomass, biofuels, conventional hydroelectric, dams, pump storage dams, tidal power, wave energy, wind, and geothermal. However, depending on the geographic location where energy is consumed, consumption of energy from these other sources is much less than from fossil fuels.

Although use of renewable energy sources continues to increase, it is projected that demand for energy from fossil fuels will not abate in the near future. Worldwide energy demand continues to grow at an increasing rate as developing countries in Asia, Central America and South America increase their energy usage. It has been projected that worldwide energy consumption will rise about 39% over the next 20 years. According to one estimate, at current consumption rates, readily available oil reserves will last about 40 years, coal reserves will last about 210 years and natural gas reserves will last about 60 years. Therefore, depletion of fossil fuel reserves is a growing concern to both developed and developing countries.

In addition, use of fossil fuels presents environmental challenges. For this reason, it would be preferable if use of an on-site power generation facility avoided burning of fossil fuels in order to avoid a deleterious impact on the environment. In this regard, use of fossil fuels produces environmental pollution, such as carbon dioxide, that may contribute to undesirable climate change. Drilling for oil can damage the environment due to inadvertent release of oil from oil rig drilling platforms and transportation of oil can damage the environment due to oil leaks from pipelines and ocean-going tankers. In addition to carbon dioxide, burning of coal produces sulfur dioxide, which can lead to corrosive “acid rain.” Acid rain is acidic and can harm plants, aquatic animals and damage building structures. Also, mining of coal can alter vast tracts of land in an undesirable manner and pose safety risks for miners. In addition, transportation and use of natural gas requires particular attention to safety because natural gas is highly flammable.

Thus, use of on-site electricity production instead of or as a back-up to use of large-scale central power station electricity production is desirable. As indicated hereinabove, on-site at the consumption site or at transmission or distribution substations for electricity production can reduce energy costs, avoid energy losses in transmission and distribution lines, increase national security, provide electrical energy to remotely located facilities and individuals, provide back-up power for critical use facilities, conserve fossil fuel reserves and possibly reduce damage to the environment due to burning fossil fuels.

Attempts have been made to provide suitable small-scale electric power plants. For example, U.S. Pat. No. 4,629,904 to Rojo, Jr. et al. discloses a small-scale hydroelectric generator that has a micro-hydro axial-flow turbine mounted in a lower end of a “penstock”, preferably of the siphon type, through which water is diverted from an intake basin, namely a river. A penstock is a pipe or conduit used to carry water to a water wheel or turbine. According to this patent, stationary vanes are located in an annular constriction of the penstock for delivering actuating flow of water against fixed blades of a rotor. This patent discloses that the flow of water is delivered at an optimum angle on the order of 90° for maximum transfer of energy from the water flow to the turbine. However, the Rojo, Jr. et al. disclosure apparently requires that the hydroelectric generator be located near a river.

A portable, self contained power conversion unit is disclosed by U.S. Pat. No. 4,731,545 to Lerner, et al. According to this patent, a portable, self-contained power conversion unit is attached to an outlet for a pressurized fluid system, such as the nozzle for a garden hose. An impeller is mounted in the body of the unit and is rotated by the discharge of pressurized fluid through the unit. The rotational energy of the impeller is converted into electrical energy by a generator, and/or used directly in rotating tools attached to the impeller, such as grinding wheels, rotary saws, rotary brushes, drill bits, and the like. Lerner, et al. state that sources of pressurized fluid are commonly available and give, as examples, water supply systems found in modern households and cities, the water main systems supplying fire hydrants, and farm irrigation systems that operate on the basis of natural artesian pressure or pump-supplied artesian pressure. However, the Lerner, et al. disclosure apparently requires that the portable, self-contained power conversion unit be located near commonly available sources of pressurized water, such as city pressurized water supplies. Even when the device is used at farms, the water supply is apparently required to be from a nearby natural artesian water source from which water is retrieved by means of natural pressure or by means of pump-supplied pressure. Moreover, the Lerner, et al. device appears suitable merely for use with relatively small appliances and tools rather than being suitable for use as a prime or main power source at large facilities, such as resorts, medical facilities and military bases.

U.S. Pat. No. 7,466,035 B1 to Srybnik, et al. discloses a transportable hydroelectric power generating system which is capable of being fully or partially assembled in a factory setting and then transported to a water stream. Thus, the Syrbnik, et al. device apparently requires location of the transportable hydroelectric power generating system at a water stream.

A mobile container power plant is disclosed by U.S. Pat. No. 7,576,442 to Auer. According to this patent, the device allows a mobile power plant to be produced which provides an electric current without the emission of pollutants. The fuel to power the mobile container power plant is a mixture of water and methanol, or the employment of natural gas. In this regard, Auer discloses that the mobile container power plant permits employment of all conventional combustion engines. Auer also discloses that the mobile container power plant may be set up wherever it is required, such as at housing complexes, hospitals, social establishments, and factories in regions where power supply is not possible. However, Auer appears to contemplate use of a fossil fuel (i.e., natural gas) to provide power for the mobile container power plant. Auer also appears to contemplate use of methanol, which is produced from biomass or from a mixture of carbon dioxide and water. However, it is known in the art that methanol is also produced from fossil fuels. Thus, Auer apparently uses a combustion process and fuels that, at least in part, depend on availability of fossil fuels.

Although the prior art approaches recited hereinabove may disclose a small-scale hydroelectric generator; a portable, self-contained power conversion unit; a transportable hydroelectric power generating system; and a mobile container power plant, the prior art recited hereinabove do not appear to disclose the invention described and claimed hereinbelow.

### SUMMARY OF THE INVENTION

The present invention addresses the shortcomings of the prior art approaches mentioned hereinabove by providing a fluid-driven power generation apparatus and system for generating electricity and a method of assembling the fluid-driven power generation apparatus. The fluid can be any suitable fluid, such as water. As previously mentioned, the prior art recited hereinabove appear to disclose a small-scale hydroelectric generator; a portable, self-contained power conversion unit; a transportable hydroelectric power generating system; and a mobile container power plant. However, the prior art recited hereinabove do not appear to disclose a fluid-driven power generation device that in no case requires use of fossil fuels or combustion to generate electricity. Also, the prior art recited hereinabove do not appear to disclose a fluid-driven power generation device that avoids use of fossil fuels and combustion in combination with being locatable at a site remote from utility transmission/distribution lines. In addition, the prior art recited hereinabove do not appear to disclose such a fluid-driven power generation device that can be located remotely from natural water sources, such as lakes, rivers, streams and aquifers. The invention described and claimed herein addresses these limitations of the prior art.

According to an aspect of the present invention, there is provided a fluid-driven power generation apparatus for generating electricity, comprising: a container for containing a fluid; a rotatable turbine wheel associated with the container for rotatably receiving the fluid; a pump associated with the container and the turbine wheel for pumping the fluid from the container to the turbine wheel; an electrical generator associated with the turbine wheel for generating the electricity as the turbine wheel rotates, the electricity having a voltage defining a voltage waveform; a converter associated with the electrical generator, the converter being adapted to selectively direct the voltage to an end user facility and to an electrical transmission grid; and a power supply associated with the pump for continuously operating the pump free of fossil fuel combustion.

According to another aspect of the present invention, there is provided a fluid-driven power generation apparatus for generating electricity, comprising: a container for sealably containing a fluid therein; a rotatable turbine wheel disposed relative to the container for rotatably receiving the fluid; an electrically operable pump disposed relative to the turbine wheel and adapted to be in fluid communication with the fluid for pumping the fluid from the container to the turbine wheel; an electrical generator coupled to the turbine wheel for generating the electricity as the turbine wheel rotates, the electricity having a voltage defining a voltage waveform; a converter electrically coupled to the electrical generator, the converter being adapted to selectively direct the electricity to an end user facility or optionally to an electrical transmission grid; and a power supply electrically coupled to the pump for continuously supplying electricity to the pump, so that the pump continuously operates to pump the fluid free of fossil fuel combustion.

According to yet another aspect of the present invention there is provided a fluid-driven power generation system for generating electricity, comprising: a container for containing a fluid; a rotatable turbine wheel associated with the container for rotatably receiving the fluid; a pump associated with the container and the turbine wheel for pumping the fluid from the container to the turbine wheel; an electrical generator associated with the turbine wheel for generating the electricity as the turbine wheel rotates, the electricity having a voltage defining a voltage waveform; a converter associated with the electrical generator, the converter being adapted to selectively direct the voltage to an end user facility and to an electrical transmission grid; and a power supply associated with the pump for continuously operating the pump free of fossil fuel combustion.

According to still another aspect of the present invention there is provided a fluid-driven power generation system for generating electricity, comprising: a container for sealably containing a fluid therein; a rotatable turbine wheel disposed relative to the container for rotatably receiving the fluid; an electrically operable pump disposed relative to the turbine wheel and adapted to be in fluid communication with the fluid for pumping the fluid from the container to the turbine wheel; an electrical generator coupled to the turbine wheel for generating the electricity as the turbine wheel rotates, the electricity having a voltage defining a voltage waveform; a converter electrically coupled to the electrical generator, the converter being adapted to selectively direct the electricity to an end user facility or optionally to an electrical transmission grid; and a power supply electrically coupled to the pump for continuously supplying electricity to the pump, so that the pump continuously operates to pump the fluid free of fossil fuel combustion.

According to another aspect of the present invention there is provided a method of assembling a fluid-driven power generation apparatus for generating electricity, comprising the steps of: providing a container for containing a fluid; providing a turbine wheel adapted to be coupled to the container for rotatably receiving the fluid; providing a pump adapted to be coupled to the container and the turbine wheel for pumping the fluid from the container to the turbine wheel; providing an electrical generator adapted to be coupled to the turbine wheel for generating the electricity as the turbine wheel rotates, the electricity having a voltage defining a voltage waveform; providing a converter adapted to be coupled to the electrical generator, the converter being adapted to selectively direct the voltage to an end user facility and to an electrical transmission grid; and providing a power supply adapted to be coupled to the pump for continuously operating the pump free of fossil fuel combustion.

According to an additional aspect of the present invention there is provided a method of assembling a fluid-driven power generation apparatus for generating electricity, comprising the steps of: providing a container for sealably containing a fluid therein; disposing a rotatable turbine wheel relative to the container, the turbine wheel being adapted to rotatably receive the fluid; disposing an electrically operable pump relative to the turbine wheel, the pump being adapted to be in fluid communication with the fluid for pumping the fluid from the container to the turbine wheel; coupling an electric generator to the turbine wheel for generating electricity as the turbine wheel rotates, the electricity having a voltage defining a voltage waveform; electrically coupling a converter to the electrical generator, the converter being adapted to selectively direct the electricity to an end user facility or optionally to an electrical transmission grid; and electrically coupling a power supply to the pump for continuously supplying electricity to the pump, so that the pump continuously operates to pump the fluid free of fossil fuel combustion.

A feature of the present invention is the provision of a turbine wheel for rotatably receiving a fluid from a container containing the fluid.

Another feature of the present invention is the provision of a pump for pumping the fluid from the container to the turbine wheel.

An additional feature of the present invention is the provision of a converter adapted to selectively direct voltage to an end user facility and to an electrical transmission grid.

Yet another feature of the present invention is the provision of a power supply associated with the pump for continuously operating the pump free of fossil fuel combustion.

In addition to the foregoing, various other method and/or device aspects and features are set forth and described in the teachings, such as text (e.g., claims and/or detailed description) and/or drawings of the present invention.

The foregoing is a summary and thus may contain simplifications, generalizations, inclusions, and/or omissions of detail. Consequently, those skilled in the art will appreciate that the summary is illustrative only and is not intended to be in any way limiting. In addition to the illustrative aspects, embodiments, and features described hereinabove, further aspects, embodiments, and features will become apparent by reference to the drawings and the following detailed description.

### BRIEF DESCRIPTION OF THE DRAWINGS

The invention will be more fully understood by reference to the detailed description in conjunction with the following figures, wherein:

FIG. 1 is a schematic illustrating a first embodiment fluid-driven power generation apparatus and system for generating electricity;

FIG. 2 is a fragmentary view in elevation of a first embodiment turbine wheel, the first embodiment turbine wheel including a plurality of inclined pinwheel turbine blades, the blades being distributed around a peripheral region delimited by a dashed line, as shown;

FIG. 3 is a fragmentary view in perspective of the first embodiment turbine wheel, this view showing an angular orientation of a representative one of the inclined pinwheel turbine blades;

FIG. 4 is a fragmentary view in elevation of a second embodiment turbine wheel, the second embodiment turbine wheel including a plurality of bucket-shaped turbine blades;

FIG. 5 is a plan view of the second embodiment turbine wheel disposed in an upper portion of a fluid container, the upper portion of the fluid container being shown in horizontal section;

FIG. 6 is a graph of alternating current voltage as a function of time;

FIG. 7 is a graph of direct current voltage as a function of time;

FIG. 8 is a schematic illustrating a second embodiment fluid-driven power generation apparatus and system for generating electricity;

FIG. 9 is a schematic illustrating a third embodiment fluid-driven power generation apparatus and system for generating electricity; and

FIGS. 10 and 11 are flowcharts of illustrative methods of assembling a fluid-driven power generation apparatus.

### DETAILED DESCRIPTION OF PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from either the spirit or scope of the invention.

In addition, the present patent specification uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

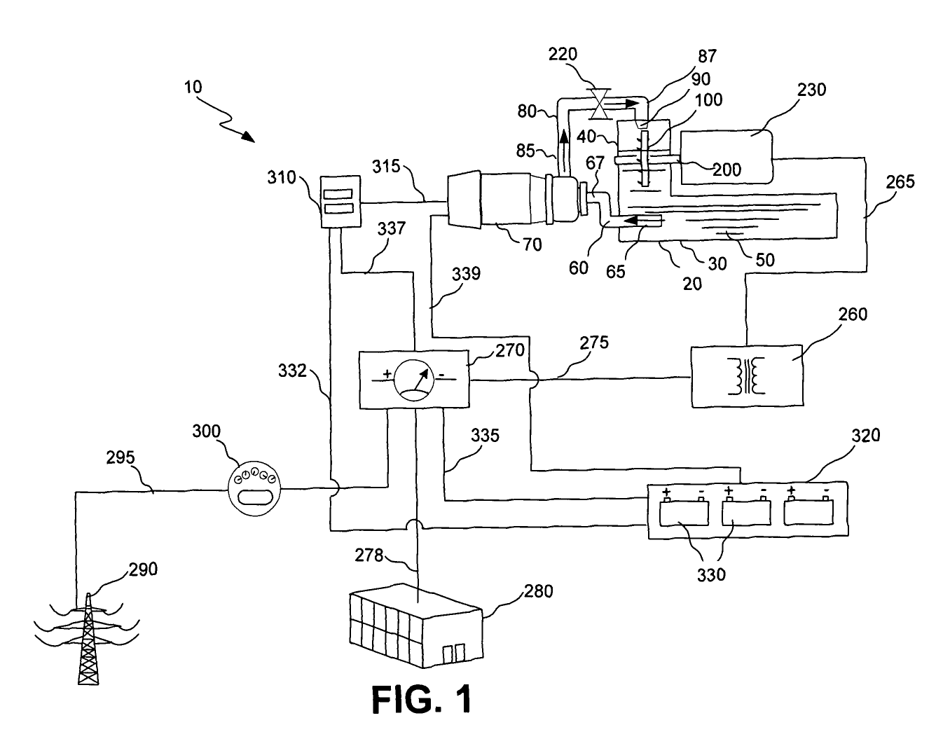

Therefore, with reference to FIG. 1, there is shown a first embodiment fluid-driven power generation apparatus and system, generally referred to as 10, for generating electricity (hereinafter referred to as “first embodiment system 10”). First embodiment system 10 comprises a sealable and hollow container 20, which may be generally L-shaped in vertical cross-section. In this regard, L-shaped container 20 defines a horizontal lower portion 30 that may have a generally cylindrical or rectangular transverse cross-section or any suitable transverse cross-section. Container 20 also defines an upright upper portion 40 that is integrally connected to lower portion 30. Upper portion 40 may have a generally cylindrical or rectangular transverse cross-section or any suitable transverse cross-section. Sealably disposed in container 20, and thus sealably disposed in lower portion 30 and upper portion 40, is a fluid body 50 for reasons provided hereinbelow. The fluid body 50 may comprise only water, a mixture of water and other substance or any suitable fluid. For example, fluid body 50 may include a mixture of water and a corrosion inhibitor for inhibiting corrosion of container 20 and corrosion of other components of first embodiment system 10 that may contact the fluid. Although not critical, fluid body 50 may completely fill the interior of lower portion 30 and rise to a predetermined level within upper portion 40, such that a predetermined hydraulic head is established by the fluid within container 20. As described in detail hereinbelow, fluid body 50 is used to generate electrical power.

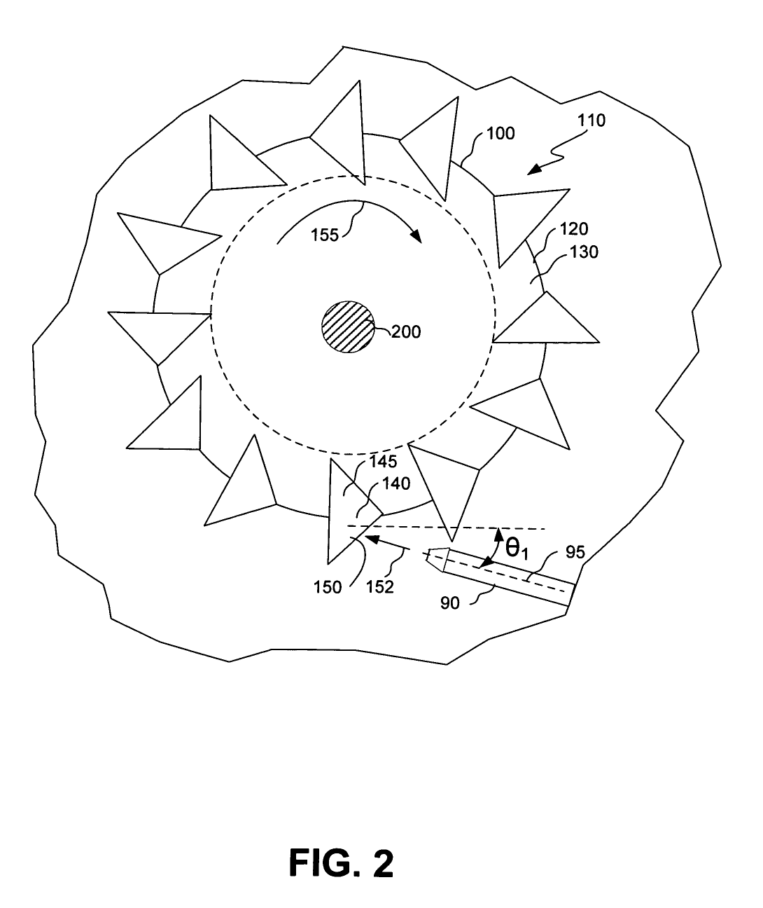

Referring again to FIG. 1, a first penstock or conduit 60 sealably penetrates lower portion 30 of container 20 and has a first end portion 65 that is in fluid communication with fluid body 30. A second end portion 67 of first conduit 60 is connected to an inlet of an electrically operable pump 70 for reasons disclosed presently. A second penstock or conduit 80 has a first end portion 85 connected to an outlet of pump 70. In addition, a second end portion 87 of second conduit 80 may sealably penetrate upper portion 40 of container 20, such that second end portion 87 is in communication with an interior of upper portion 40 that is defined by container 20. A nozzle 90 is coupled to second end portion 87 of second conduit 80 and has a constricted outlet disposed in upper portion 40 to jet the fluid into upper portion 40, for purposes disclosed hereinbelow. Nozzle 90 defines a center axis 95 therethrough (see FIG. 2).

Still referring to FIG. 1, pump 70 siphons or suctions the fluid from lower portion 30 of container 20, through first conduit 60 and to the inlet of pump 70. Thereafter, pump 70 pumps the fluid from the outlet of pump 70, through second conduit 80 and to nozzle 90. The fluid then jets from the outlet of nozzle 90 and into the interior of upper portion 40 of container 20. In this manner, pump 70 pumps the fluid from lower portion 30 to upper portion 40 of container 20, for reasons disclosed momentarily.

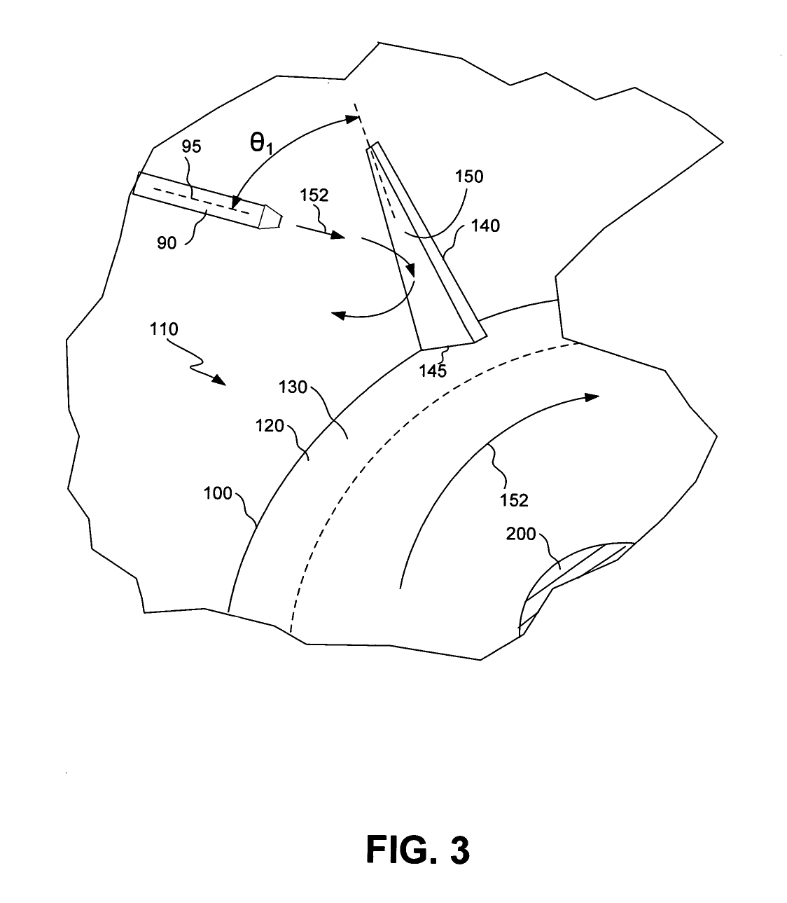

Referring to FIGS. 1, 2 and 3, disposed in upper portion 40 of container 20 is a rotatable turbine wheel 100, which may be a first embodiment rotatable turbine wheel generally referred to as 110. First embodiment turbine wheel 110 rotatably receives the fluid jetted from nozzle 90. More specifically, first embodiment turbine wheel 110 comprises a generally circular hub 120 defining an annular peripheral region 130 extending around hub 120, as delimited and shown by a dotted line. Distributed around hub 120 and integrally connected thereto is a plurality of inclined pinwheel turbine blades 140. Each of pinwheel turbine blades 140 may be generally triangular in configuration with a bottom edge 145 disposed within and affixed to peripheral region 130. Each pinwheel turbine blade 140 defines a fluid-receiving planer or flat surface 150 thereon for receiving the fluid jetted by nozzle 90. In order to optimally receive the fluid jetted by nozzle 90, surface 150 is oriented or inclined at a predetermined angle theta-one “θ₁” as measured between inclined surface 150 and center axis 95 that is defined by nozzle 90. The angle theta-one “θ₁” is selected so that surface 150 preferably presents the maximum surface area to the stream of fluid jetting from nozzle 90. Presenting the maximum surface area to the stream of fluid jetting from nozzle 90 allows surface 150 to receive maximum kinetic energy from the fluid jetting against surface 150. In this regard, the angle theta-one “θ₁” may be selected as 90°. Thus, receiving maximum kinetic energy from the fluid jetting against surface 150, such as along fluid flow line 152, allows first embodiment turbine wheel 110 to rotate optimally. That is, receiving maximum kinetic energy from the fluid jetting against surface 150 allows first embodiment turbine wheel 110 to rotate, such as in the direction of an arrow 155, at a maximum speed. In other words, first embodiment turbine wheel 110 will rotate at a maximum speed for a given fluid pressure jetting from nozzle 90. For example, a first fluid pressure value P1 will produce a first maximum speed or angular velocity V1, a second fluid pressure P2 will produce a second maximum speed or angular velocity V2, a third fluid pressure P3 will produce a third maximum speed or angular velocity V3, and so on. It may be appreciated by a person of ordinary skill in the art of fluid pump design that controlling operation of pump 70 controls the fluid pressure jetting from nozzle 90 and, therefore, provides means for controlling the maximum speed of first embodiment turbine wheel 110.

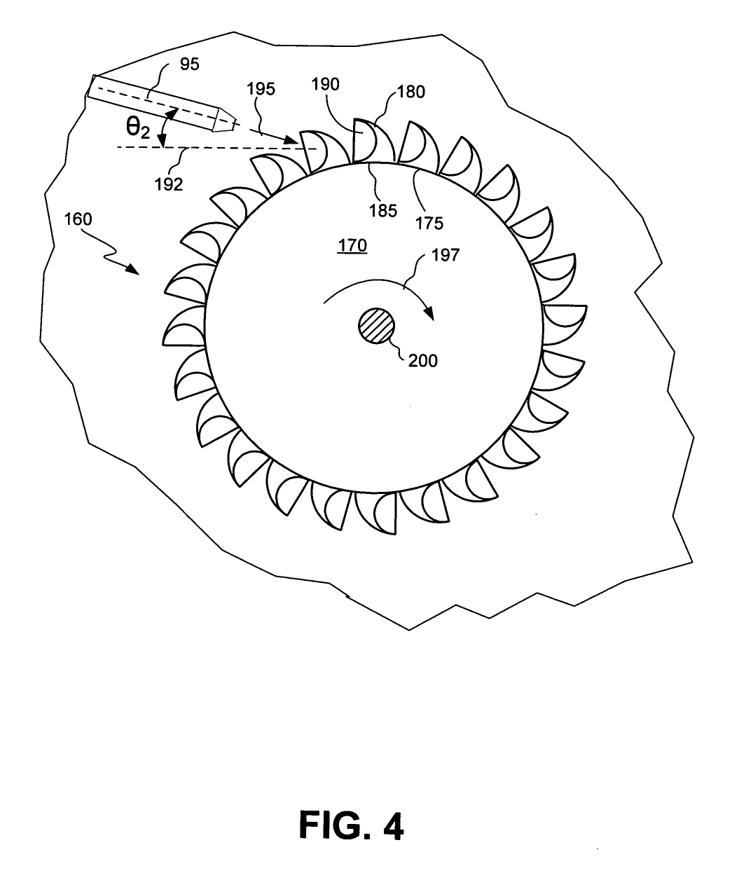

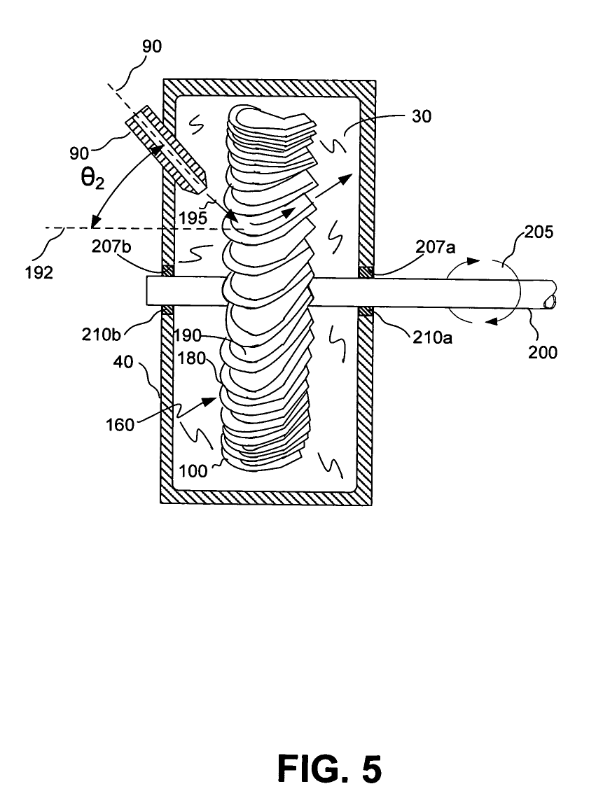

Turning now to FIGS. 4 and 5, another configuration of rotatable turbine wheel 100 is there shown, which may be a second embodiment rotatable turbine wheel generally referred to as 160. Second embodiment turbine wheel 160 rotatably receives the fluid jetted from nozzle 90. Second embodiment turbine wheel 160 is a modified and improved configuration of the conventional Turgo-type turbine rotor. More specifically, second embodiment turbine wheel 160 comprises a generally circular hub 170 defining a peripheral edge 175 therearound, as shown. Distributed around hub 170 and integrally connected to edge 175 is a plurality of bucket-shaped turbine blades 180. Each of bucket-shaped turbine blades 180 has a bottom portion 185 thereof affixed to edge 175 of hub 170. Each bucket-shaped turbine blade 180 defines a fluid-receiving concave surface 190 thereon for receiving the fluid jetted by nozzle 90. In order to optimally receive the fluid jetted by nozzle 90, surface 190 is oriented at a predetermined angle theta-two “θ₂” as measured between an axis 192 passing through a center of surface 190 and center axis 95 that is defined by nozzle 90. Axis 192 is preferably normal to surface 190. The angle theta-two “θ₂” is selected so that surface 190 presents the center of surface 190 to the stream of fluid jetting from nozzle 90. Presenting the center of surface 190 to the stream of fluid jetting from nozzle 90 allows bucket-shaped turbine blade 140 to receive maximum kinetic energy from the fluid jetting against surface 190 of bucket-shaped turbine blade 140. Thus, receiving maximum kinetic energy from the fluid jetting against surface 190, such as along fluid flow line 195, allows second embodiment turbine wheel 160 to rotate optimally. That is, receiving maximum kinetic energy from the fluid jetting against surface 190 allows second embodiment turbine wheel 160 to rotate, such as in the direction of an arrow 197, at a maximum speed. In other words, second embodiment turbine wheel 160 will rotate at a maximum speed for a given fluid pressure jetting from nozzle 90. For example, a first fluid pressure value P1 will produce a first maximum speed or angular velocity V1, a second fluid pressure P2 will produce a second maximum speed or angular velocity V2, a third fluid pressure P3 will produce a third maximum speed or angular velocity V3, and so on. It may be appreciated by a person of ordinary skill in the art of fluid pump design that controlling operation of pump 70 controls the fluid pressure jetting from nozzle 90 and, therefore, provides means for controlling the maximum speed of second embodiment turbine wheel 160.

Referring to FIGS. 1, 2, 3, 4 and 5, either first embodiment turbine wheel 110 or second embodiment turbine wheel 160, as the case may be, is mounted on an elongate rotatable turbine shaft 200 that is capable of rotating in the direction of arrows 205. For the purpose of brevity, turbine shaft 200 will be described with respect to its interaction with second embodiment turbine wheel 160, it being understood that the description herein also pertains to interaction of turbine shaft 200 with first embodiment turbine wheel 110, as well. In this regard, turbine shaft 200, which is oriented normal to hub 170, extends through the center of hub 170 and is affixed to second embodiment turbine wheel 160 at the center of hub 170. Thus, turbine shaft 200 is caused to rotate as second embodiment turbine wheel 160 rotates. Moreover, turbine shaft 200 is sealably received through a pair of oppositely disposed openings 207a and 207b in upper portion 40 of container 20 when turbine shaft 200 is affixed to the center of hub 170. As previously indicated, second embodiment turbine wheel 160 is disposed in the interior of upper portion 40 of container 20. Therefore, it may be appreciated that second embodiment turbine wheel 160 may be at least partially surrounded by the fluid residing in upper portion 40 of container 20 and is exposed to the fluid jetting from nozzle 90, as previously mentioned. Thus, although not critical, it is nonetheless important that any gap between turbine shaft 200 and openings 207a and 207b be sealed by high pressure-resistant and high temperature-resistant annular gaskets or seals 210a and 210b to prevent the fluid from leaking from upper portion 40 of container 20. Seals 210a/210b may be an elastomeric material (e.g., nitrile rubber), a polymeric material (e.g., polytetrafluoroethylene), a metalic material (e.g., stainless steel) or a mixture of these materials. In this manner, volume of fluid within container 20 can remain substantially unchanged and recirculated. Therefore, need for providing a make-up fluid source to replenish body of fluid 30 is unnecessary. In addition, if desired, a control valve 220 may be coupled to second conduit 80 and in fluid communication with the fluid in second conduit 80 for controlling flow of the fluid to nozzle 90. Therefore, the invention provides dual control means for controlling flow of the fluid to nozzle 90. That is, control valve 220 can be used to control flow of the fluid as well as pump 70. This may be particularly useful if pump 70 malfunctions and/or cannot be turned-off In this case, control valve 220 can be used as a shut-off valve to prevent flow of fluid to nozzle 90, so as to allow either replacement or maintenance of pump 70.

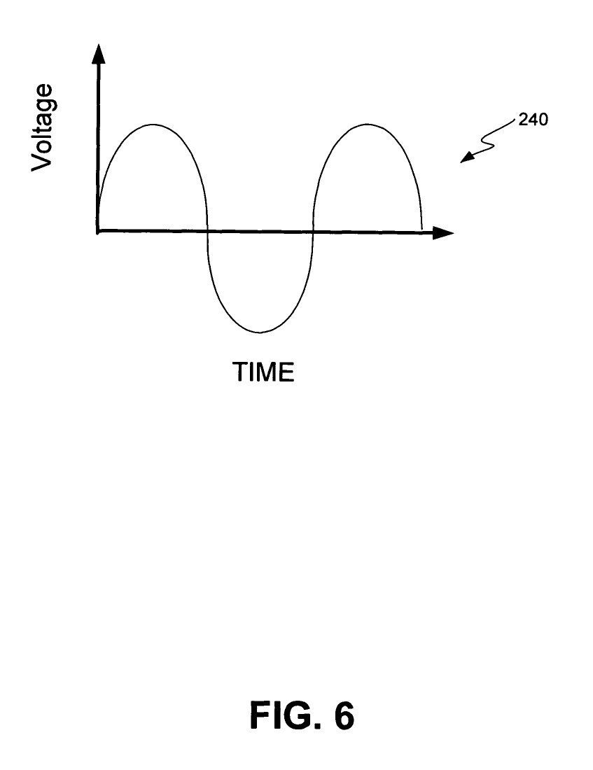

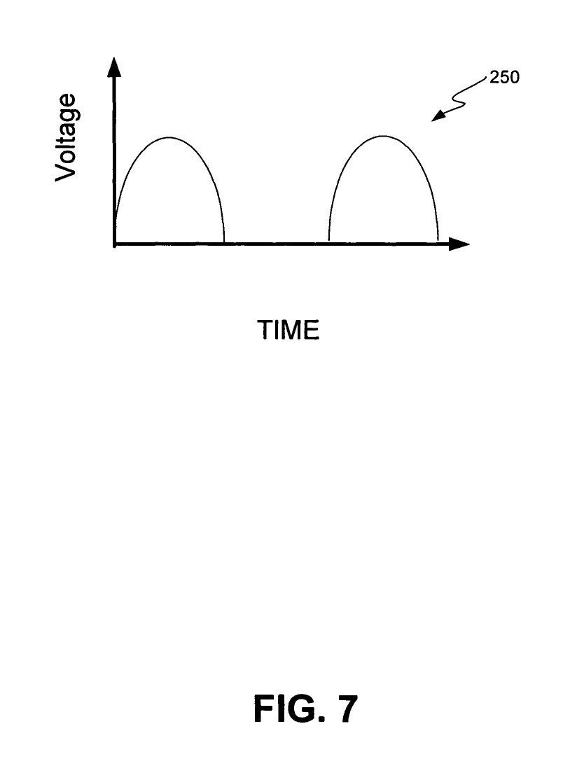

As seen in FIGS. 1, 6 and 7, an end portion of turbine shaft 200 is coupled to a conventional electrical generator 230. Electrical generator 230 may generate an alternating current (AC) waveform, generally referred to as 240. In this regard, turbine shaft 200 is connected to a magnetic core rotor (not shown), which may be a permanent magnet, for rotating the magnetic core rotor as turbine shaft 200 rotates in the manner disclosed hereinabove. The magnetic core rotor is disposed within a stationary wire-wound stator (also not shown). As the magnetic core rotor rotates, an AC current is induced in the stator due to the rotating magnetic field of the rotor. The AC current is delivered to a circuit carrying the electrical load. Alternatively, electrical generator 230 may be selected so as to generate a direct current (DC) waveform, generally referred to as 250. In this regard, the DC current configuration of electrical generator 230 is substantially similar to the AC current configuration of electrical generator 230, except that a commutator (not shown) is mounted on rotating turbine shaft 200. The commutator reverses the current into the coils to provide a unidirectional current. Carbon brushes (also not shown) transfer the DC current from the rotating commutator to the circuit carrying the load.

Referring to FIG. 1, when electrical current from electrical generator 230 is AC, the voltage corresponding to the AC current is transferred to a conventional transformer 260, such as along an electrical connection 265. In this case, transformer 260 may be a “step-up” transformer for increasing AC voltage transferred by electrical generator 230. Such increased voltage is beneficial for transmitting electrical energy over long distances, such as over an electrical transmission/distribution network, because increasing voltage in this manner reduces amperage and the effects of electrical resistance. Alternatively, transformer 260 may be a “step-down” transformer for decreasing AC voltage transmitted by electrical generator 230. Such decreased voltage can be beneficial. For example, such decreased voltage can be used in instances when a lower voltage of 110 volts is desirable, rather than a higher voltage, for operating lower voltage machinery, office equipment, appliances and other items requiring lower voltage. As well known in the art of electrical power generation, transformer 260 is only useable with AC current, rather than DC current, due to the inherent operating characteristics of transformer 260. Thus, according to the invention, transformer 260 is configured such that, when the electricity generated by electrical generator 230 is DC current, the voltage corresponding to the DC current can travel through transformer 260 without being stepped-up or stepped-down.

Still referring to FIGS. 1, 6 and 7, electrical energy from transformer 260 is transferred to a converter 270, such as along electrical connection 275. Converter 270 is adapted to convert AC waveform 240 to DC waveform 250, when desired. Alternatively, converter 270 is adapted to convert DC waveform 250 to AC waveform 240, when desired. According to the invention, converter 270 can convert DC current to AC current, and then transfer that AC current, such as along electrical connection 278, to an on-site end user facility 280. Another step-down transformer (not shown) may be interposed between converter 270 and end user facility 280 for reducing the voltage to a value suitable for operating the previously mentioned lower voltage machinery, office equipment, appliances and other items requiring lower voltage. The end user facility 280 may, for example, be a vacation resort, medical facility, military base facility or other end user facility. On the other hand, if desired, converter 270 can also convert AC current to DC current and then transfer that DC current to an electrical transmission network or grid 290, such as along electrical connection 295. Voltage corresponding to the DC current is more suitable for transmission over long distances, such as the long distances covered by grid 290. Thus, it should be appreciated that “excess” electrical energy (i.e., electrical energy not used by user facility 280) may be provided by converter 270 to grid 290. In this regard, a meter 300 is coupled to electrical connection 295 for metering or measuring electrical energy supplied to grid 290. When electrical energy is sold to the utility operating grid 290, meter 300 is used to measure the amount of electrical energy delivered to grid 290 in order to determine the amount of revenue to be received by supplying the “excess” electrical energy to grid 290. According to the invention, converter 270 includes switchgears (not shown) for providing electrical energy supply either to end user facility or to grid 290. The switchgears comprise conventional switches and/or circuit breakers that regulate and direct electrical energy either to end user facility 280 or to grid 290.

Referring again to FIG. 1, a primary power supply 310 is coupled to previously mentioned electrically operable pump 70 such as along electrical connection 315. Power supply 310, which includes a battery, continuously operates to provide an uninterrupted source of power to operate pump 70. Power supply 310 is also non-polluting because power supply 310 operates without use or combustion of fossil fuels, such as petroleum in the form of gasoline. An auxiliary battery bank 320 comprising a plurality of batteries 330 is connected to power supply 310, such as along electrical connection 332, for providing back-up power should power supply 310 fail or otherwise malfunction and cease providing electrical power to pump 70. Battery bank 320 may also be connected to converter 270, if desired, for providing electrical power to converter 270. In this case, the electrical power provided to converter 270, such as along electrical connection 335, can be switched by the switchgears in converter 270 to supply the back-up power to power supply 310, such as along electrical connection 337. Supplying power from battery bank 320 to converter 270 and then to power supply 310 provides an alternative circuit for providing back-up power to pump 70 should power supply 310 fail or malfunction. In addition, to provide additional assurance that uninterrupted power is supplied to pump 70, battery bank 320 may be directly connected to pump 70, such as along electrical connection 339. Supplying power directly from battery bank 320 to pump 70 provides yet another alternative circuit for providing back-up power to pump 70 should power supply 310 fail or malfunction.

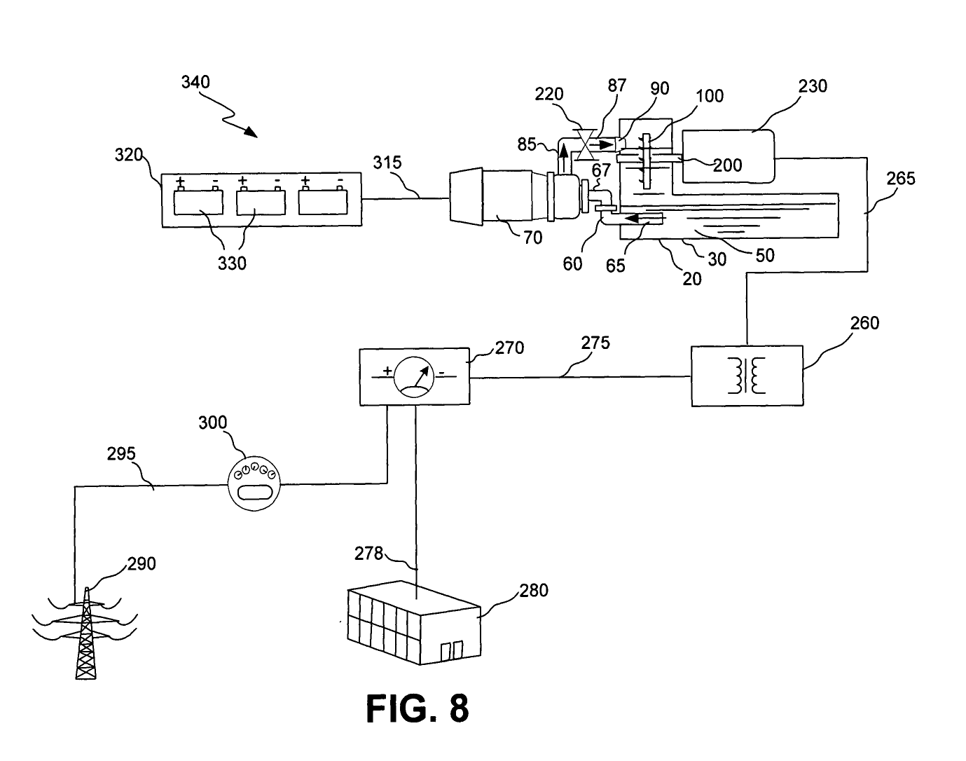

Turning now to FIG. 8, there is shown a second embodiment fluid-driven power generation apparatus and system, generally referred to as 340, for generating electricity (hereinafter referred to as “second embodiment system 340”). Second embodiment system 340 is substantially similar to first embodiment system 10, except that power supply 310, electrical connection 332, electrical connection 335, electrical connection 337 and electrical connection 339 are absent. Rather, battery bank 320 is connected directly to pump 70 by means of previously mentioned electrical connection 315 and therefore serves as the power supply. In this manner, second embodiment system 340 provides less complexity and therefore presumably obtains a lower capital cost when compared to first embodiment system 10. However, in this case, battery bank 320 should desirably have a high reliability because there is no auxiliary back-up power circuit.

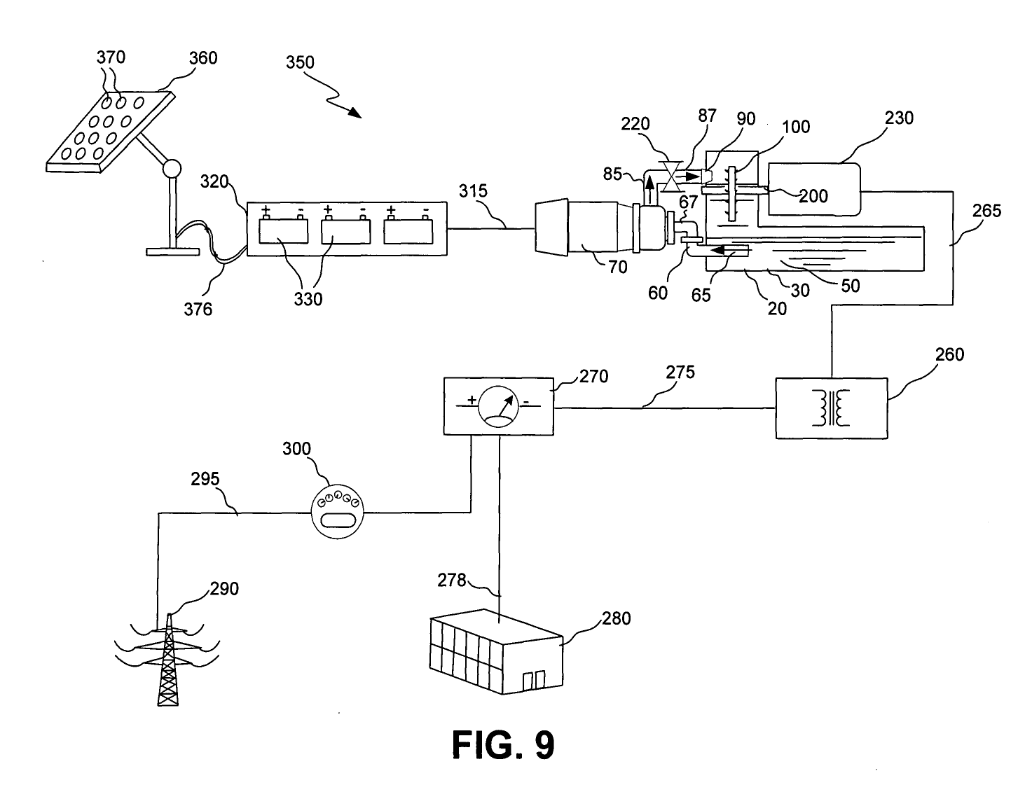

With reference to FIG. 9, there is shown a third embodiment fluid-driven power generation apparatus and system, generally referred to as 350, for generating electricity (hereinafter referred to as “third embodiment system 350”). Third embodiment system 350 is substantially similar to second embodiment system 340, except that batteries 330 that belong to battery bank 320 are rechargeable. In this regard, a solar panel 360 comprising a plurality of solar cells 370 is electrically connected, such as along electrical connection 376, to battery bank 320 for recharging batteries 330, either periodically or continuously depending on the availability of sun light. In this manner, DC power is continuously supplied to pump 70. Known suitable materials evincing the photoelectric effect may be selected from the group consisting essentially of monocrystalline silicon, polycrystalline silicon, amorphous silicon, cadmium telluride, copper indium selenide, copper indium sulfide and mixtures thereof. The DC current generated by solar panel 360 is received by battery bank 320 for electrically energizing and recharging battery bank 320. To achieve this result, batteries 330 belonging to battery bank 320 may be composed of any one of well-known rechargeable battery materials, such as Nickel-Cadmium (NiCd), Nickel-Metal Hydride (NiMH) or Lithium-Ion (Li⁺).

### Illustrative Methods

Illustrative methods associated with exemplary embodiments for assembling the fluid-driven power generation apparatus will now be described.

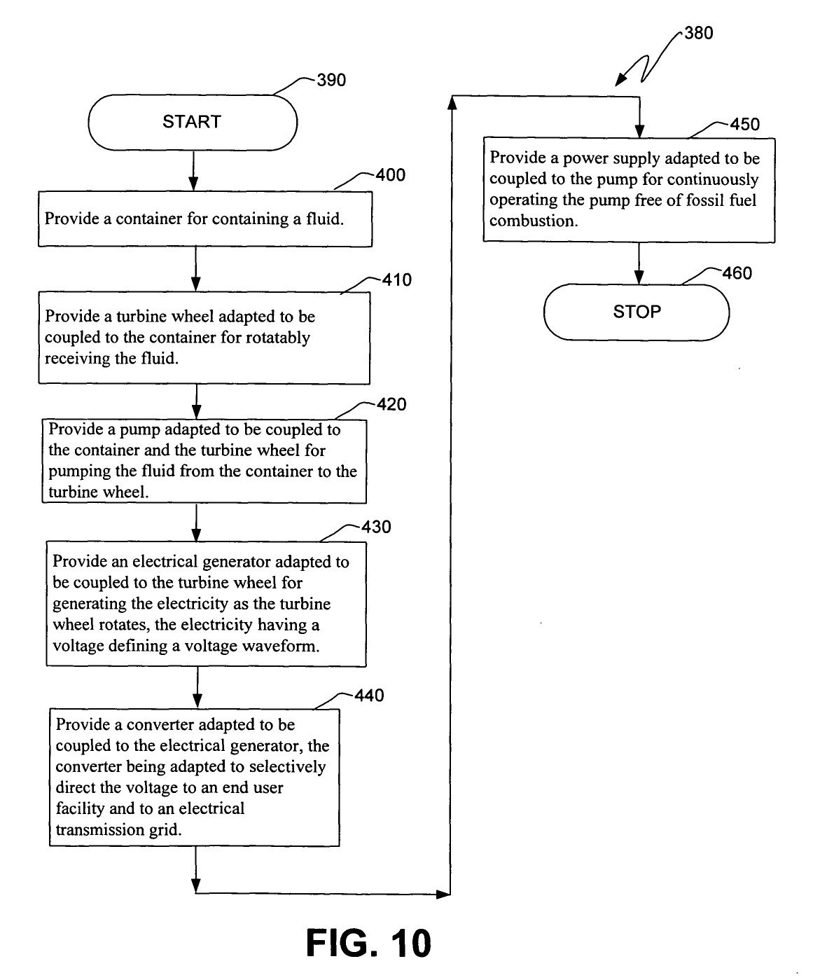

Referring to FIG. 10, an illustrative method 380 that is provided for assembling a fluid-driven power generation apparatus starts at a block 390. At a block 400, a container for containing a fluid is provided. At a block 410, a turbine wheel adapted to be coupled to the container for rotatably receiving the fluid is provided. At a block 420, a pump adapted to be coupled to the container and the turbine wheel is provided for pumping the fluid from the container to the turbine wheel, At a block 430, an electrical generator adapted to be coupled to the turbine wheel is provided for generating the electricity as the turbine wheel rotates, the electricity having a voltage defining a voltage waveform. At a block 440, a converter adapted to be coupled to the electrical generator is provided, the converter being adapted to selectively direct the voltage to an end user facility and to an electrical transmission grid. At a block 450, a power supply adapted to be coupled to the pump is provided for continuously operating the pump free of fossil fuel combustion. The method stops at a block 460.

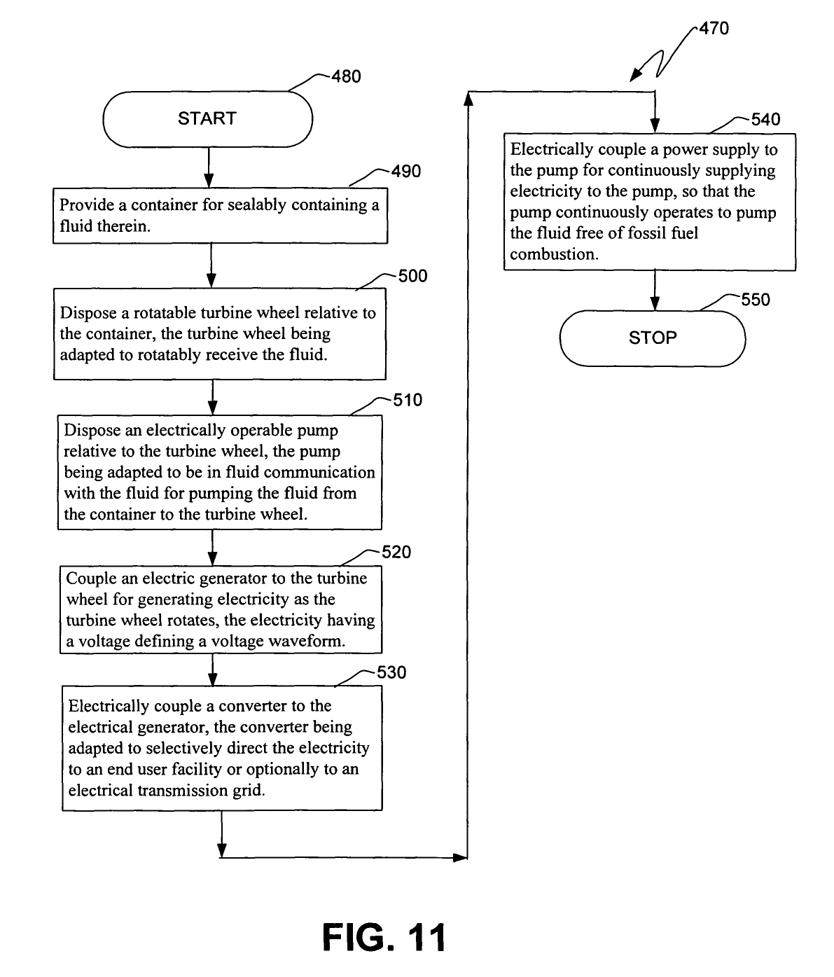

Referring to FIG. 11, an illustrative method 470 that is provided for assembling a fluid-driven power generation apparatus starts at a block 480. At a block 490 a container for sealably containing a fluid therein is provided. At a block 500, a rotatable turbine wheel is disposed relative to the container, the turbine wheel being adapted to rotatably receive the fluid. At a block 510, an electrically operable pump is disposed relative to the turbine wheel, the pump being adapted to be in fluid communication with the fluid for pumping the fluid from the container to the turbine wheel, At a block 520, an electric generator is coupled to the turbine wheel for generating electricity as the turbine wheel rotates, the electricity having a voltage and a waveform. At a block 530, a converter is electrically coupled to the electrical generator, the converter being adapted to selectively direct the electricity to an end user facility or optionally to an electrical transmission grid. At a block 540, a power supply is electrically coupled to the pump for continuously supplying electricity to the pump, so that the pump continuously operates to pump the fluid free of fossil fuel combustion. The method stops at a block 550.

It should be appreciated from the teachings herein that the fluid-driven apparatus and system 10/340/350 may be sited at a location remote from a source of water, such as a lake, stream, river or aquifer. In addition, the fluid-driven apparatus and system 10/340/350 is locatable remotely from a transmission/distribution electrical grid, if desired. Thus, the fluid-driven apparatus and system 10/340/350 may be deployed at remote sites, such as vacation resorts, isolated military bases, and consumers living in remote areas. Also, the fluid-driven apparatus and system 10/340/350 may be used as back-up emergency power at critical facilities, such as medical facilities and military installations. Further, the fluid-driven apparatus and system 10/340/350 avoids use of fossil fuels to generate electricity and is, therefore, pollution-free.

Other modifications and implementations will occur to those skilled in the art without departing from the spirit and the scope of the invention as claimed. For example, meter 300 may be a “smart meter” and grid 290 may be a “smart grid”, such that grid 290 is capable of digitally and automatically requesting electrical energy from the fluid-driven apparatus and system 10/340/350 when needed and meter 300 is capable of digitally and automatically assessing whether “excess” electrical energy is available from the fluid-driven apparatus and system 10/340/350. In this case, meter 300 would automatically instruct the fluid-driven apparatus and system 10/340/350 to automatically supply the excess electrically energy to grid 290. Accordingly, the description hereinabove is not intended to limit the invention, except as indicated in the following claims.

Therefore, provided herein are a fluid-driven power generation apparatus and system for generating electricity and a method of assembling the fluid-driven power generation apparatus.

What is claimed is:

1. A fluid-driven power generation apparatus for generating electricity, comprising:
(a) a container for containing a fluid;
(b) a rotatable turbine wheel associated with said container for rotatably receiving the fluid;
(c) a pump associated with said container and said turbine wheel for pumping the fluid from said container to said turbine wheel;
(d) an electrical generator associated with said turbine wheel for generating the electricity as the turbine wheel rotates, the electricity having a voltage defining a voltage waveform;
(e) a converter associated with said electrical generator, said converter being adapted to selectively direct the voltage to an end user facility and to an electrical transmission grid; and
(f) a power supply associated with said pump for continuously operating said pump free of fossil fuel combustion.

2. The fluid-driven power generation apparatus of claim 1, further comprising a nozzle coupled to said container and adapted to be in fluid communication with the fluid for jetting the fluid from an opening defined by said nozzle.

3. The fluid-driven power generation apparatus of claim 2, wherein said turbine wheel comprises a turbine blade oriented relative to the opening defined by said nozzle for facilitating rotation of said turbine wheel.

4. The fluid-driven power generation apparatus of claim 1, wherein said power supply comprises a battery.

5. The fluid-driven power generation apparatus of claim 4, further comprising a solar cell associated with said battery for charging said battery.

6. The fluid-driven power generation apparatus of claim 1, further comprising a transformer associated with said electrical generator for transforming the voltage.

7. The fluid-driven power generation apparatus of claim 1, wherein said converter is adapted to convert the voltage waveform.

8. A fluid-driven power generation apparatus for generating electricity, comprising:
(a) a container for sealably containing a fluid therein;
(b) a rotatable turbine wheel disposed relative to said container for rotatably receiving the fluid;
(c) an electrically operable pump disposed relative to said turbine wheel and adapted to be in fluid communication with the fluid for pumping the fluid from said container to said turbine wheel;
(d) an electrical generator coupled to said turbine wheel for generating the electricity as said turbine wheel rotates, the electricity having a voltage defining a voltage waveform;
(e) a converter electrically coupled to said electrical generator, said converter being adapted to selectively direct the electricity to an end user facility or optionally to an electrical transmission grid; and
(f) a power supply electrically coupled to said pump for continuously supplying electricity to said pump, so that said pump continuously operates to pump the fluid free of fossil fuel combustion.

9. The fluid-driven power generation apparatus of claim 8, further comprising a nozzle coupled to said container and adapted to be in fluid communication with the fluid for jetting the fluid from an opening defined by said nozzle.

10. The fluid-driven power generation apparatus of claim 9, further comprising a valve coupled to said nozzle for controlling the jetting of the fluid from the opening defined by said nozzle.

11. The fluid-driven power generation apparatus of claim 9, wherein said turbine wheel comprises a turbine blade oriented at a predetermined angle relative to the opening defined by said nozzle for facilitating optimum rotation of said turbine wheel.

12. The fluid-driven power generation apparatus of claim 8, wherein said power supply comprises a battery.

13. The fluid-driven power generation apparatus of claim 12, wherein said battery is rechargeable.

14. The fluid-driven power generation apparatus of claim 13, further comprising a solar panel electrically coupled to said battery for electrically recharging said battery.

15. The fluid-driven power generation apparatus of claim 8, further comprising a transformer electrically coupled to said electrical generator for transforming the voltage.

16. The fluid-driven power generation apparatus of claim 15, wherein said transformer is a step-up transformer electrically coupled to the electrical transmission grid for increasing the voltage and for providing the increased voltage to the electrical transmission grid.

17. The fluid-driven power generation apparatus of claim 15, wherein said transformer is a step-down transformer electrically coupled to the end user facility for decreasing the voltage and for providing the decreased voltage to the end user facility.

18. The fluid-driven power generation apparatus of claim 8, wherein said converter is adapted to convert the voltage waveform.

19. The fluid-driven power generation apparatus of claim 18, wherein said converter is adapted to convert the voltage waveform from a direct current voltage waveform to an alternating current voltage waveform.

20. The fluid-driven power generation apparatus of claim 18, wherein said converter is adapted to convert the voltage waveform from an alternating current voltage waveform to a direct current voltage waveform.

21. The fluid-driven power generation apparatus of claim 8, further comprising a meter coupled to said electrical generator and the electrical transmission grid for metering the electricity selectively directed to the electrical transmission grid.

22. A fluid-driven power generation system for generating electricity, comprising:
(a) a container for containing a fluid;
(b) a rotatable turbine wheel associated with said container for rotatably receiving the fluid;
(c) a pump associated with said container and said turbine wheel for pumping the fluid from said container to said turbine wheel;
(d) an electrical generator associated with said turbine wheel for generating the electricity as the turbine wheel rotates, the electricity having a voltage defining a voltage waveform;
(e) a converter associated with said electrical generator, said converter being adapted to selectively direct the voltage to an end user facility and to an electrical transmission grid; and
(f) a power supply associated with said pump for continuously operating said pump free of fossil fuel combustion.

23. The fluid-driven power generation system of claim 22, further comprising a nozzle coupled to said container and adapted to be in fluid communication with the fluid for jetting the fluid from an opening defined by said nozzle.

24. The fluid-driven power generation system of claim 23, wherein said turbine wheel comprises a turbine blade oriented relative to the opening defined by said nozzle for facilitating rotation of said turbine wheel.

25. The fluid-driven power generation system of claim 22, wherein said power supply comprises a battery.

26. The fluid-driven power generation system of claim 25, further comprising a solar cell associated with said battery for charging said battery.

27. The fluid-driven power generation system of claim 22, further comprising a transformer associated with said electrical generator for transforming the voltage.

28. The fluid-driven power generation system of claim 22, wherein said converter is adapted to convert the voltage waveform.

29. A fluid-driven power generation system for generating electricity, comprising:
(a) a container for sealably containing a fluid therein;
(b) a rotatable turbine wheel disposed relative to said container for rotatably receiving the fluid;
(c) an electrically operable pump disposed relative to said turbine wheel and adapted to be in fluid communication with the fluid for pumping the fluid from said container to said turbine wheel;
(d) an electrical generator coupled to said turbine wheel for generating the electricity as said turbine wheel rotates, the electricity having a voltage defining a voltage waveform;
(e) a converter electrically coupled to said electrical generator, said converter being adapted to selectively direct the electricity to an end user facility or optionally to an electrical transmission grid; and
(f) a power supply electrically coupled to said pump for continuously supplying electricity to said pump, so that said pump continuously operates to pump the fluid free of fossil fuel combustion.

30. The fluid-driven power generation system of claim 29, further comprising a nozzle coupled to said container and adapted to be in fluid communication with the fluid for jetting the fluid from an opening defined by said nozzle.

31. The fluid-driven power generation system of claim 30, further comprising a valve coupled to said nozzle for controlling the jetting of the fluid from the opening defined by said nozzle.

32. The fluid-driven power generation system of claim 30, wherein said turbine wheel comprises a turbine blade oriented at a predetermined angle relative to the opening defined by said nozzle for facilitating optimum rotation of said turbine wheel.

33. The fluid-driven power generation system of claim 29, wherein said power supply comprises a battery.

34. The fluid-driven power generation system of claim 33, wherein said battery is rechargeable.

35. The fluid-driven power generation system of claim 34, further comprising a solar panel electrically coupled to said battery for electrically recharging said battery.

36. The fluid-driven power generation system of claim 29, further comprising a transformer electrically coupled to said electrical generator for transforming the voltage.

37. The fluid-driven power generation system of claim 36, wherein said transformer is a step-up transformer electrically coupled to the electrical transmission grid for increasing the voltage and for providing the increased voltage to the electrical transmission grid.

38. The fluid-driven power generation system of claim 36, wherein said transformer is a step-down transformer electrically coupled to the end user facility for decreasing the voltage and for providing the decreased voltage to the end user facility.

39. The fluid-driven power generation system of claim 29, wherein said converter is adapted to convert the voltage waveform.

40. The fluid-driven power generation system of claim 39, wherein said converter is adapted to convert the voltage waveform from a direct current voltage waveform to an alternating current voltage waveform.

41. The fluid-driven power generation system of claim 39, wherein said converter is adapted to convert the voltage waveform from an alternating current voltage waveform to a direct current voltage waveform.

42. The fluid-driven power generation system of claim 29, further comprising a meter coupled to said electrical generator and the electrical transmission grid for metering the electricity selectively directed to the electrical transmission grid.

43. A method of assembling a fluid-driven power generation apparatus for generating electricity, comprising the steps of:
(a) providing a container for containing a fluid;
(b) providing a turbine wheel adapted to be coupled to the container for rotatably receiving the fluid;
(c) providing a pump adapted to be coupled to the container and the turbine wheel for pumping the fluid from the container to the turbine wheel;
(d) providing an electrical generator adapted to be coupled to the turbine wheel for generating the electricity as the turbine wheel rotates, the electricity having a voltage defining a voltage waveform;
(e) providing a converter adapted to be coupled to the electrical generator, the converter being adapted to selectively direct the voltage to an end user facility and to an electrical transmission grid; and
(f) providing a power supply adapted to be coupled to the pump for continuously operating the pump free of fossil fuel combustion.

44. The method of claim 43, further comprising the step of coupling a nozzle to the container, the nozzle being adapted to be in fluid communication with the fluid for jetting the fluid from an opening defined by the nozzle.

45. The method of claim 44, wherein the step of providing a turbine wheel comprises the step of providing a turbine wheel having a turbine blade oriented relative to the nozzle for facilitating rotation of the turbine wheel.

46. The method of claim 43, wherein the step of providing a power supply comprises the step of providing a battery.

47. The method of claim 46, wherein the step of providing a power supply comprises the step of providing a solar cell adapted to be coupled to the battery for charging the battery.

48. The method of claim 43, further comprising the step of providing a transformer adapted to be coupled to the electrical generator for transforming the voltage.

49. The method of claim 43, wherein the step of providing a converter comprises the step of providing a converter adapted to convert the voltage waveform.

50. A method of assembling a fluid-driven power generation apparatus for generating electricity, comprising the steps of:
(a) providing a container for sealably containing a fluid therein;
(b) disposing a rotatable turbine wheel relative to the container, the turbine wheel being adapted to rotatably receive the fluid;
(c) disposing an electrically operable pump relative to the turbine wheel, the pump being adapted to be in fluid communication with the fluid for pumping the fluid from the container to the turbine wheel;
(d) coupling an electric generator to the turbine wheel for generating electricity as the turbine wheel rotates, the electricity having a voltage defining a voltage waveform;
(e) electrically coupling a converter to the electrical generator, the converter being adapted to selectively direct the electricity to an end user facility or optionally to an electrical transmission grid; and
(f) electrically coupling a power supply to the pump for continuously supplying electricity to the pump, so that the pump continuously operates to pump the fluid free of fossil fuel combustion.

51. The method of claim 50, further comprising the step of coupling a nozzle to the container, the nozzle being adapted to be in fluid communication with the fluid for jetting the fluid from an opening defined by the nozzle.

52. The method of claim 51, further comprising the step of coupling a valve to the nozzle for controlling the jetting of the fluid from the opening defined by the nozzle.

53. The method of claim 51, wherein the step of disposing a rotatable turbine wheel comprises the step of disposing a rotatable turbine wheel having a turbine blade adapted to be oriented at a predetermined angle relative to the opening defined by the nozzle for facilitating optimum rotation of the turbine wheel.

54. The method of claim 50, wherein the step of electrically coupling a power supply comprises the step of electrically coupling a battery.

55. The method of claim 54, wherein the step of electrically coupling a battery comprises the step of electrically coupling a rechargeable battery.

56. The method of claim 55, further comprising the step of electrically coupling a solar panel to the battery for electrically recharging the battery.

57. The method of claim 50, further comprising the step of electrically coupling a transformer to the electrical generator for transforming the voltage.

58. The method of claim 57, wherein the step of electrically coupling the transformer comprises the step of electrically coupling a step-up transformer to the electrical transmission grid for increasing the voltage and for providing the increased voltage to the electrical transmission grid.

59. The method of claim 57, wherein the step of electrically coupling the transformer comprises the step of electrically coupling a step-down transformer to the end user facility for decreasing the voltage and for providing the decreased voltage to the end user facility.

60. The method of claim 50, wherein the step of electrically coupling a converter comprises the step of electrically coupling a converter adapted to convert the voltage waveform.

61. The method of claim 60, wherein the step of electrically coupling a converter adapted to convert the voltage waveform comprises the step of electrically coupling a converter adapted to convert the voltage waveform from a direct current voltage waveform to an alternating current voltage waveform.

62. The method of claim 60, wherein the step of electrically coupling a converter adapted to convert the voltage waveform comprises the step of electrically coupling a converter adapted to convert the waveform from an alternating current voltage waveform to a direct current voltage waveform.

63. The method of claim 50, further comprising the step of coupling a meter to the electrical generator and the electrical transmission grid for metering the electricity selectively directed to the electrical transmission grid.
